(19) United States
(12) Patent Application Publication
(10) Pub. No.: US 2004/0205469 A1
(43) Pub. Date: Oct. 14, 2004

(54) Method for processing a rule using computer-independent program instructions and computer for use therewith

(76) Inventor: Nathan D. Mellor, Camas, WA (US)

Correspondence Address: HEWLETT-PACKARD COMPANY, Intellectual Property Administration, P.O. Box 272400, Fort Collins, CO, 80527-2400, US

(21) Appl. No.: 10/177,878

(22) Filed: Jun. 19, 2002

(51) Int. Cl. G06F 15/00

(52) U.S. Cl. 715/500; 715/513

(57) ABSTRACT

A method for processing a rule using computer-independent program instructions comprises describing a rule that determines variable data to be printed on a print article in a variable data print campaign. The method further includes processing a first style sheet and the rule resulting in a second style sheet, wherein the first and second style sheets are expressed in computer-independent program instructions.

### BACKGROUND OF THE INVENTION

In a variable data print campaign, printed matter such as an advertising brochure or other type of print articles includes variable data placed within copy holes based on a set of rules that govern the print campaign. For example, a campaign rule may include placing certain variable data within a copy hole based on the age of the intended recipient of the print article. Thus, in the event that the intended recipient is over 55 years of age, the variable data placed within the copy hole might include information about travel and leisure activities. In the event that the recipient is a teenager, a campaign rule may indicate that the variable data placed within the copy hole includes information about various colleges or universities. Through the use of campaign rules such as these, certain variable data can be placed within copy holes of the print article thereby enabling greater personalization of printed matter distributed to the recipients. Variable data print campaigns are sometimes referred to as one-to-one print campaigns in which unique print articles are prepared and conveyed to individuals according to the campaign rules.

Variable data print campaigns typically make use of computer programs that receive rules from a print campaign manager who inputs the rules as algebraic expressions. The computer program then parses the expressions before interpreting and executing the interpreted expressions. The parsing and interpretation of these rules is typically performed using compiled, specialized software that can add substantial cost to the variable data print campaign. Further, the need for specialized software to perform parsing and interpretation of the expressed rules decreases the appeal of conducting a variable data print campaign since only those computing resources that are furnished with the specialized software can perform the functions required to execute the variable data print campaign.

For example, a variable data print campaign may require the use of a database that includes the name, address, and other specific information of individual recipients of each print article. Further, the database may not be readily accessible to the computing resource furnished with the specialized software that receives, parses, and executes the algebraically expressed rules. Thus, in order to generate each print article, the database must be made accessible to the specific computing resource, either by conveying the database to the computing resource, or by configuring the computing resource and/or an intervening network resource to enable the database to be accessed by the computing resource.

### BRIEF DESCRIPTION OF THE DRAWINGS

FIG. 1 is a block diagram of a computer that performs a method for processing a rule using computer-independent program instructions according to a preferred embodiment of the invention;

FIG. 2 is an exemplary description of a rule expressed using computer-independent program instructions according to a preferred embodiment of the invention;

FIG. 3 is a block diagram that shows processing of a rule expressed using computer-independent program instructions according to a preferred embodiment of the invention;

FIG. 4 represents an exemplary description of a style sheet suitable for processing a list of recipients intended to receive print articles according to a preferred embodiment of the invention;

FIG. 5 is a block diagram showing processing of a data list and a list processor style sheet used for processing a rule expressed using computer-independent program instructions according to a preferred embodiment of the invention;

FIG. 6 is a block diagram showing additional processing of a rule expressed using computer-independent program instructions according to a preferred embodiment of the invention;

FIG. 7 is an exemplary print article resulting from a method for processing a rule using computer-independent program instructions according to a preferred embodiment of the invention; and

FIG. 8 is a flowchart of a method for processing a rule using computer-independent program instructions according to a preferred embodiment of the invention.

### BRIEF DESCRIPTION OF THE APPENDICES

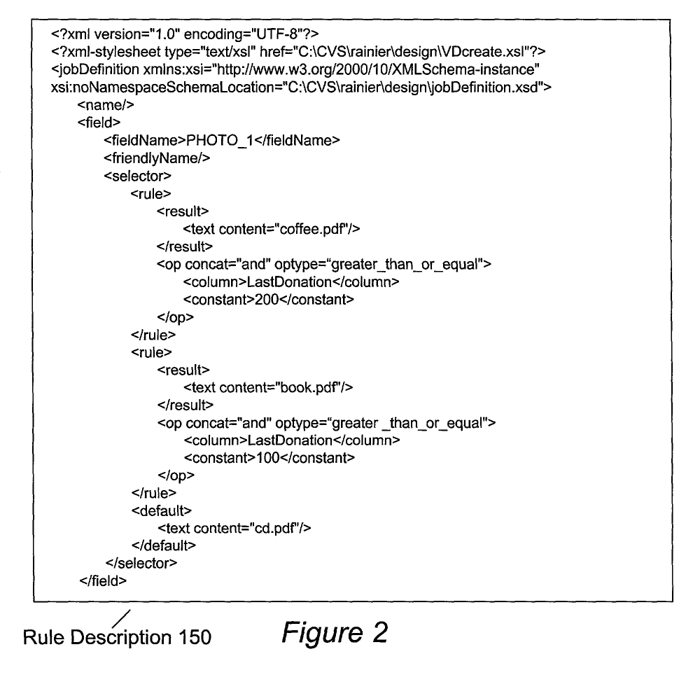

Appendix A: Additional exemplary rule descriptions including the description of rule 150 of FIG. 2.

Appendix B: Complete listing of variable data style sheet 210 of FIG. 2.

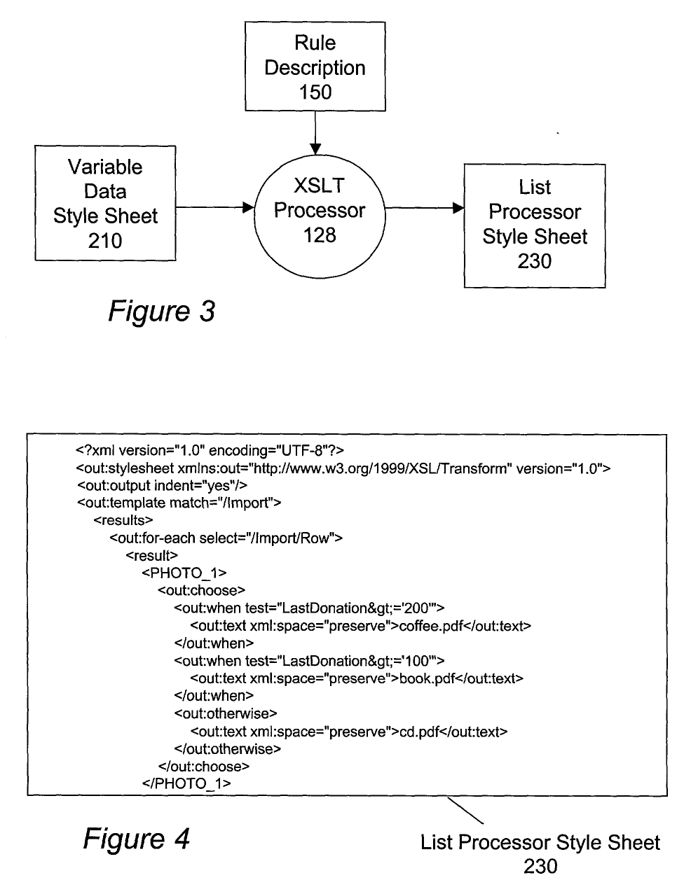

Appendix C: Complete listing of exemplary list processor XSL style sheet (230) of FIGS. 3 and 4.

### DESCRIPTION OF THE PREFERRED EMBODIMENTS

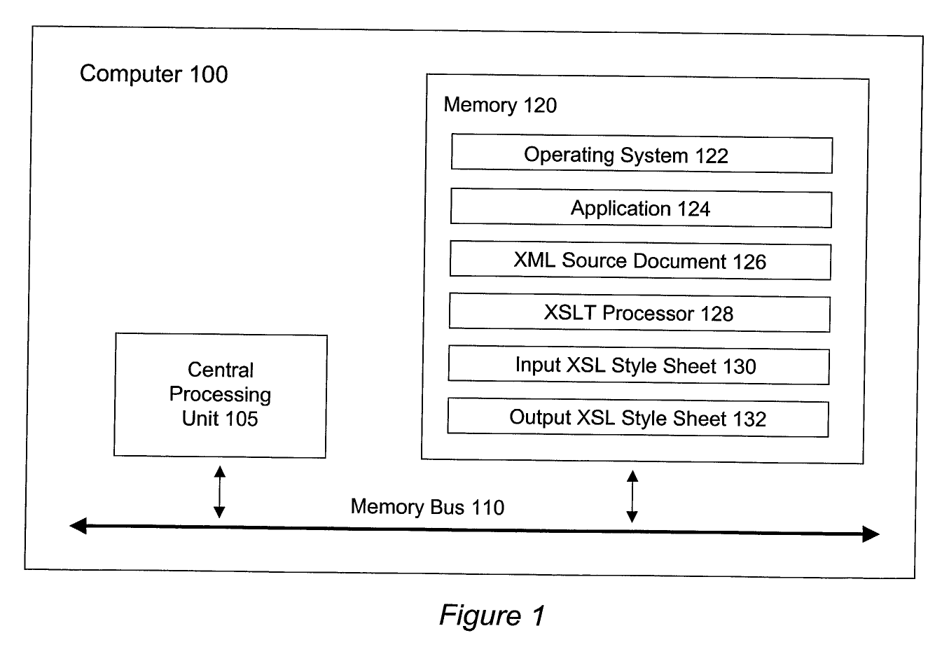

FIG. 1 is a block diagram of a computer that performs a method for processing a rule using computer-independent program instructions according to a preferred embodiment of the invention. Computer 100 can be any type of desktop, laptop, or handheld computing device capable of performing general or special purpose computing functions. Further, computer 100 may be a server or other computing resource that performs a method for processing a rule using computer-independent programs along with a variety of other functions.

In FIG. 1, computer 100 includes central processing unit 105, which is coupled to memory 120 by way of memory bus 110. Memory bus 110 may be, for example, a data bus with an accompanying control/address bus. Stored within the address space of memory 120 and executable by central processing unit 105 are operating system 122, application 124, extensible markup language (XML) source document 126, extensible style sheet template (XSLT) processor 128, input extensible style sheet (XSL) style sheet 130, and output XSL style sheet 132 that results from XSLT processor 128.

XSLT processor 128 is a software framework as well as libraries that implement XSLT transformations described in XSL Transformations (XSLT) Version 1.0 W3C Recommendation 16 Nov. 1999. This document can be found at http://www.w3.org/TR/1999/REC-xslt-19991116. XSLT processor 128 thus resides within memory 120 until being loaded into central processing unit 105. In FIG. 1, XSLT processor 128 is loaded into central processing unit 105 and acts upon XML source document 126 and input XSL style sheet 130 resulting in output XSL style sheet 132.

In a preferred embodiment, input XSL style sheet 130 represents any one of several style sheets encoded using the XSL language. Additionally, XML source document 126 represents any one of several documents described herein that is encoded using a structured data text format. Examples of XML source document 126, input XSL style sheet 130, and output XSL style sheet 132, as well as processing performed by XSLT processor 128 are described in the Figures herein.

Although the exemplary embodiment of FIG. 1 includes particular references to XML, XSL, and XSLT, nothing prevents the use of other markup languages other than XML, such as Standard Generalized Markup Language (SGML), Hypertext Markup Language (HTML), Practical Extraction and Report Language (PERL) or other language that accepts rule expressions in a structured data text format. Further, nothing prevents the use of other style sheets and templates so long as the selected style sheet and template represents substantially computer-independent programming languages capable of being processed by general or special-purpose computer systems such as computer 100.

Computer 100 may also include various peripheral devices such as, for example, a keyboard, keypad, touchpad, touch screen, microphone, scanner, mouse, joystick, one or more push buttons, and so forth. The peripheral devices may also include display devices, indicator lights, speakers, printing devices, and so forth. Specific display devices may be, for example, cathode ray tubes, liquid crystal display screens, gas plasma-based flat panel displays, or other types of display devices.

Memory 120 is contemplated herein as having both volatile or nonvolatile memory and data storage components. Volatile components include those that do not retain data values upon the loss of power. Nonvolatile components are those that retain data upon a loss of power. Thus, memory 120 may comprise random access memory (RAM), read-only memory (ROM), hard disk drives, floppy disks accessed by way of an associated floppy disk drive, compact discs accessed by way of a compact disc drive, magnetic tapes accessed by way of an appropriate tape drive, and/or other memory components, or a combination of one or more of the aforementioned memory components. In addition, the RAM may comprise static random access memory (SRAM), dynamic random access memory (DRAM), or magnetic random access memory (MRAM), and other such devices. The ROM may comprise a programmable read-only memory (PROM), erasable programmable read-only memory (EPROM), or other types of memory devices.

Additionally, central processing unit 105 may represent multiple processors and memory 120 may represent multiple memories that operate in parallel. In such an arrangement, memory bus 110 may represent an appropriate network that brings about communication between any two of the multiple processors, between any processor and any one of the memories, or between any two of the memories, and so forth. Operating system 122 of FIG. 1 is executed to control the allocation and usage of hardware resources in computer 100 such as the memory, processing time, and peripheral devices. In this manner, operating system 122 serves as a basis on which application 124 depends.

FIG. 2 is an exemplary description of a rule expressed using computer-independent program instructions according to a preferred embodiment of the invention. In FIG. 2, rule description 150 is written using the XML language and provides an example of XML source document 126 of FIG. 1. However, rule description 150 represents but one simple rule expressed in a structured data text format that could be replaced by a variety of other rule descriptions that govern the print campaign. Further, rule description 150 can be replaced by a concatenated set of rule descriptions so that FIG. 2 represents several rule descriptions written in a structured data text format that govern the variable data print campaign.

In FIG. 2, rule description 150 includes the variable “LastDonation” that determines a filename placed within a copy hole of a print article that is conveyed to a recipient. In the example of FIG. 2, if the variable “LastDonation” is greater than or equal to 200, the copy hole entitled PHOTO_1 is filled with the variable data corresponding to “coffee_cup.pdf”. If the variable “LastDonation” is greater than or equal to 100, the copy hole entitled PHOTO_1 is filled with the variable data corresponding to “book.pdf”. If the variable “LastDonation” is an amount that does not fall within either or both limits (such as when “LastDonation” equals 50), the copy hole entitled PHOTO_1 is filled with the variable data corresponding to “cd.pdf”. In this example, the files “coffee_cup.pdf”, “book.pdf”, and “cd.pdf” represent photographic assets.

Appendix A includes additional exemplary rule descriptions including rule 150 of FIG. 2.

FIG. 3 is a block diagram that shows processing of a rule expressed using computer-independent program instructions according to a preferred embodiment of the invention. In FIG. 3, rule description 150 is acted upon by XSLT processor 128 within memory 120 of computer 100 (of FIG. 1). Also acted on by XSLT processor 128 is variable data style sheet 210, which is an exemplary embodiment of input XSL style sheet 130.

A listing of an example of variable data style sheet 210 is shown in Appendix B.

In the embodiment of FIG. 3, XSLT processor 128 acts upon variable data style sheet 210 and rule description 150 resulting in list processor style sheet 230, which corresponds to output XSL style sheet 132 of FIG. 1. List processor style sheet 230 is described in more detail in the discussion of FIG. 4. List processor style sheet 230 represents a computer-independent implementation of rule description 150 that is capable of processing a list of recipients (and accompanying information specific to each recipient) that is intended to receive print articles resulting from the variable data print campaign.

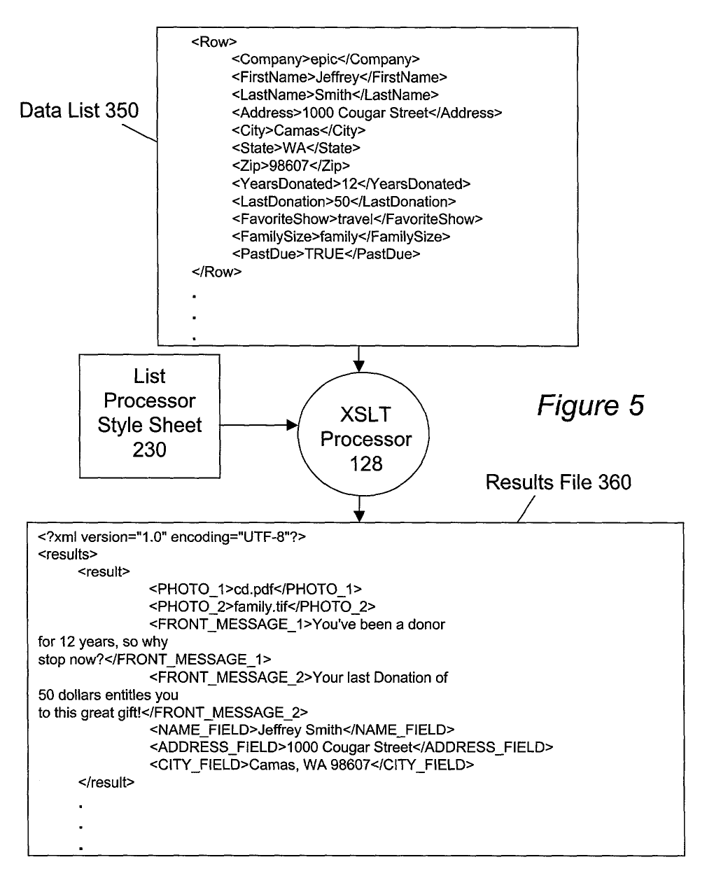

FIG. 4 represents an exemplary style sheet (230) suitable for processing a list of recipients intended to receive print articles according to a preferred embodiment of the invention. FIG. 4 also represents the computer-independent XSL program instructions that implement the campaign rules listed Appendix A (which includes rule description 150). In the example of FIG. 4, list processor style sheet 230 is capable of being acted upon with the list of recipients by way of XSLT processing in order to form results file 360, described in more detail in the discussion of FIG. 5.

FIG. 5 is a block diagram showing processing of a data list and a list processor style sheet used in processing a rule expressed using computer-independent program instructions according to a preferred embodiment of the invention. In FIG. 5, data list 350 is a group of records, wherein each record includes the name, address, and other contact information pertaining to an individual intended to receive a print article resulting from the variable data print campaign. For purposes of simplicity, only a single record is shown in FIG. 5, and additional records formatted in a manner similar to that shown in FIG. 5 are preferably also included in data list 350.

In FIG. 5, XSLT processor 128 processes data list 350 as well as list processor style sheet 230 to form results file 360. Results file 360 shows, in a raw format, one instance of an individual document template that can be used to generate a print article. Results file 360 includes the name and address of the recipient (NAME_FIELD, ADDRESS_FIELD, and CITY_FIELD), as well as other information, such as the text or an asset filename intended to fill the copy holes in the print article. Results file 360 also includes FRONT_MESSAGE_1 and FRONT_MESSAGE_2 into which the YearsDonated (12) and the LastDonation (50) variables from data list 350 have been inserted. Preferably, results file 360 includes one record, such as that shown in FIG. 5, for each recipient listed in data list 350.

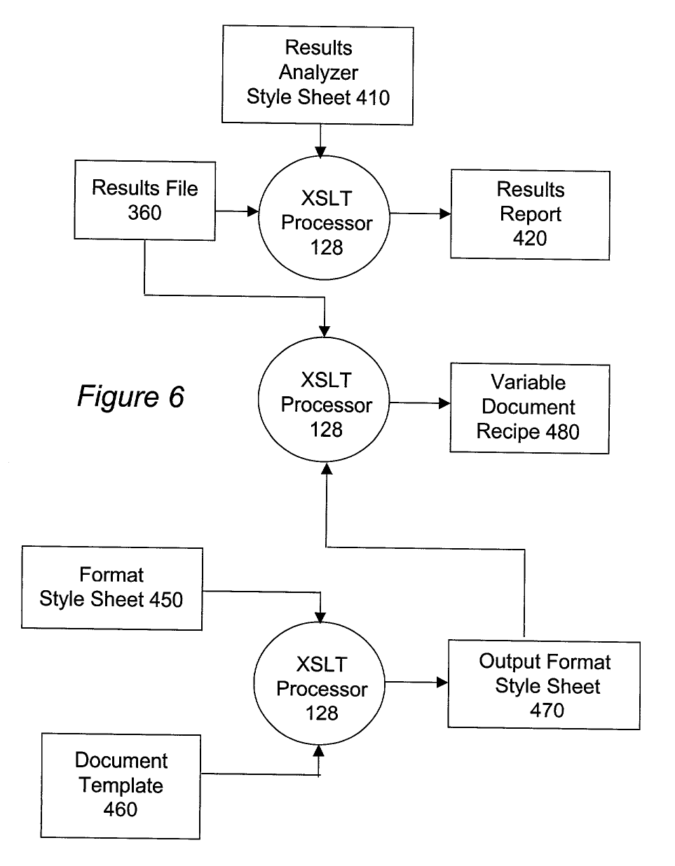

Results file 360 can be analyzed to determine the frequency at which certain variable data is placed within the copy hole of each print article. Thus, as described in greater detail in the description of FIG. 6, the results file that includes a record for each recipient listed in data list 350 can be evaluated to determine if a particular rule has been incorrectly expressed. Thus, in the example of FIG. 5, if the copy hole entitled “PHOTO_{—}1” in each instance of a print article is filled with the filename “cd.pdf”, regardless of the value of “LastDonation” in data list 350, the print campaign manager can determine that rule description 150 has been incorrectly expressed. This permits the print campaign manager to make the necessary corrections to rule description 150 prior to the actual printing of each print article of the variable data print campaign. Results file 360 can thus be used as a checkpoint during the execution of the print campaign to verify the integrity of rule description 150 as well as data list 350.

FIG. 6 is a block diagram showing additional processing of a rule expressed using computer-independent program instructions according to a preferred embodiment of the invention. As previously mentioned herein, results file 360 can be analyzed to determine the frequency at which certain variable data is placed within the copy hole of each print article. Thus, in FIG. 6, results analyzer style sheet 410 is used to analyze results file 360 using XSLT processor 128. XSLT processor 128 then produces results report 420 in which the occurrence of the placement of certain variable data within each copy hole can be determined. Although an exemplary software listing of results analyzer style sheet 410 has not been included herein, a candidate style sheet that examines the occurrence of certain text or asset filenames can be developed using syntax that accords with the syntax used to create list processor XSL style sheet 230 (FIGS. 3 and 4) and listed in Appendix C.

Also shown in FIG. 6 is the XSLT processing of format style sheet 450 and document template 460. Format style sheet 450 is designed to conform the copy hole description to a specific variable data print campaign output format. For example, a particular print campaign may use a print engine such as pdfExpress™ or Personalized Print Markup Language™ (PPML) to describe each print article to the printing device that prepares the print articles. When using either of these exemplary print engines or any other candidate print engine, format style sheet 450 is used to create an expression using a syntax that accords with the selected print engine capable of creating the print articles and processing each print article, such as performing raster image processing for use with a digital press.

In FIG. 6, document template 460 describes the template for each print article. Preferably, document template 460 provides names and descriptions of the copy holes in a basic document that is modified to create each print article. This allows the print campaign manager to be apprised of the constraints on the text or filenames intended to fill a given copy hole in the document. This description can be created interactively using computer 100 wherein the print campaign manager uploads a particular document to the computer system.

For example, in the event that pdfExpress™ is selected as the print engine for use in the print campaign, the print campaign manager desirably uploads a document along with a form that describes the design of the uploaded document. The form may include the name of each copy hole (such as PHOTO_1) and the page at which each copy hole is to be located on each print article. In another example, in which PPML is selected as the print engine, a more complete description of the uploaded document may be preferable. This description may include copy hole names and the pages of the print articles at which each copy hole appears as well as bounding boxes described on the print article using absolute coordinates.

Output format style sheet 470, which results from XSLT processor 128 of FIG. 6 acting on format style sheet 450 and document template 460, is an XSL style sheet that includes the syntactically-correct expressions that can be input directly into a printing device, such as a digital press. Thus, output format style sheet 470 acts upon results file 360 by way of XSLT processor 128 to create variable document recipe 480, which is used to control the printing device that produces each print article of the variable data print campaign.

In an alternate embodiment of the invention, computer-independent program instructions are used to describe the rules used to generate variable data World Wide Web pages. In this embodiment, the copy holes correspond to locations in a Web page wherein variable data is inserted according to the rules that govern the Web page campaign. In this embodiment, the variable document recipe 480 is prepared using syntax that accords with HTML, thereby providing a means of preparing variable data Web pages.

To bring about the instantiation of an HTML-encoded World Wide Web page, format style sheet 450 is tailored to conform the copy hole description using the selected HTML syntax. Document template 460 is also tailored to provide the name and a description of each of the copy holes of the resulting HTML document.

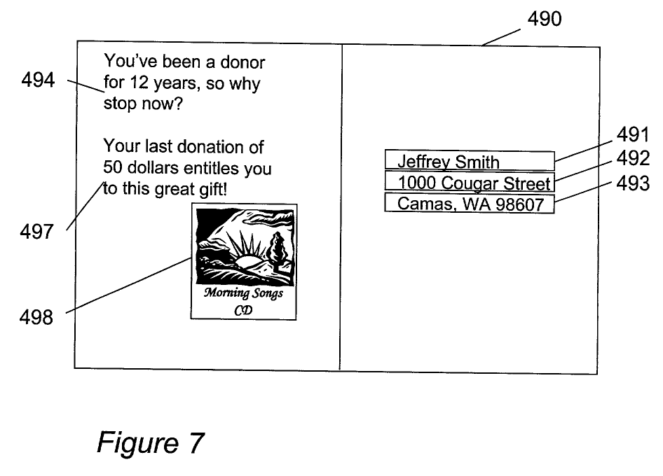

FIG. 7 is a portion (front side only) of an exemplary print article (490) that results from a method for processing a rule using computer-independent program instructions according to a preferred embodiment of the invention. The print article of FIG. 7 results from the application of rule description 150 of FIG. 2 to the recipient information present in data list 350 of FIG. 5 using variable data style sheet 210. The results file (360) that follows from this processing is combined with an output format style sheet (such as style sheet 470 of FIG. 6) that describes the placement of the copy holes on the print article. Thus, for this example, copy hole 491 includes the name and address of the recipient named “Jeffrey Smith” corresponding to NAME_FIELD in results file 360. Copy holes 492 and 493 include the street address and city, state and zip code, respectively (corresponding to ADDRESS_FIELD and CITY_FIELD in results file 360). Copy holes 494 and 497 have been filled with text that corresponds to FRONT_MESSAGE_1 and FRONT_MESSAGE_2 of results file 360. Copy holes 494 and 497 include the number of years the recipient has donated to the organization (12) and the amount of the last donation (50 dollars), respectively, which originate from data list 350 of FIG. 5.

FIG. 7 also includes copy hole 498, in which is placed a picture of a compact disc entitled “Morning Songs CD”. This picture has been placed within copy hole 498 as a result of rule description 150 of FIG. 2 in which the variable “LastDonation” is used to determine the variable data that is placed within the copy hole. According to the rule, the file “cd.pdf” is placed within the copy hole named “PHOTO_{—}1” (in results file 360) when the variable “LastDonation” is an amount less than 100 dollars. Print article 490 desirably also includes a second copy hole named “PHOTO_{—}2” placed on the reverse side of the print article (not shown in FIG. 7).

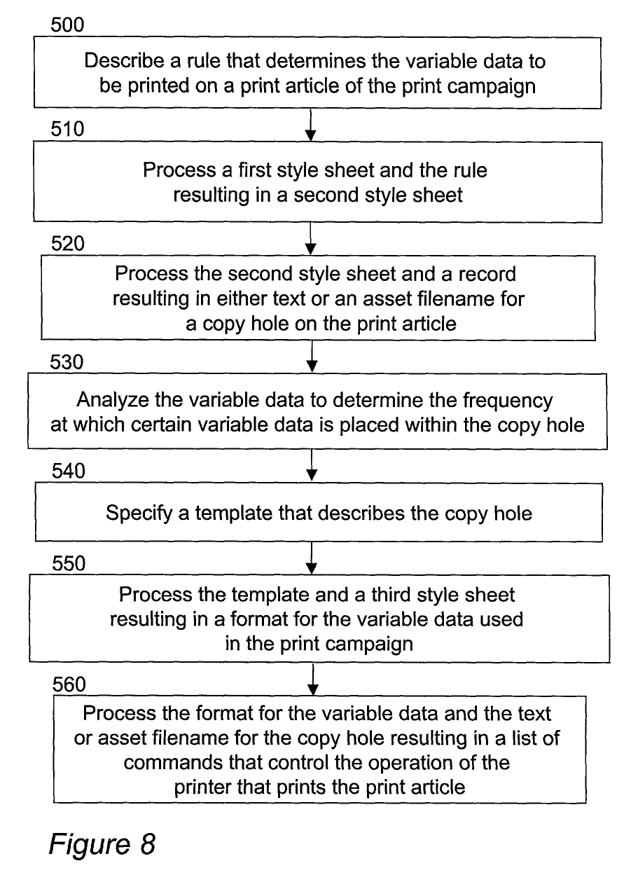

FIG. 8 is a flowchart for a method of processing a rule using computer-independent program instructions according to a preferred embodiment of the invention. The method of FIG. 8 can be practiced using computer 100 of FIG. 1. The method of FIG. 8 summarizes and recapitulates many of the steps shown and described in FIGS. 3, 5, and 6 herein.

At step 500, a print campaign manager describes a rule that determines the variable data to be printed on a print article of the print campaign. An example rule description of step 500 is rule description 150 of FIG. 2. At step 510, a first style sheet such as variable data style sheet 210 and the rule are processed by a suitable XSLT processor (such as XSLT processor 128) resulting in a second style sheet. The second style sheet of step 510 may be similar to list processor style sheet 230 described in FIGS. 3, 4, and 5 herein. At step 520, the second style sheet and a record, such as the record present in data list 350 of FIG. 5, are processed resulting in one or more of text and an asset filename for a copy hole on the print article. Examples of text and filenames that result from step 520 include FRONT_MESSAGE_1 (text) and PHOTO_1 (filename for a photographic asset) of results file 360 of FIG. 5.

In step 530, the variable data is analyzed to determine the frequency at which certain variable data is placed in the copy hole. As mentioned in relation to results report 420 of FIG. 6, step 530 can provide the print campaign manager with the opportunity to check that all rule descriptions have been expressed correctly.

The method continues at step 540 wherein the print campaign manager specifies a template that describes the copy hole. Step 540 can correspond to the uploading of document template 460 described in relation to FIG. 6. At step 550, the template and a third style sheet (such as format style sheet 450 of FIG. 6) are processed resulting in an output format (such as output format style sheet 470 of FIG. 6) for the variable data used in the print campaign. At step 560, the output format for the variable data and the text or asset filename for the copy hole are processed resulting in a list of commands that control the operation of the printing device that prints the print article. The list of commands that result from step 560 may correspond to variable document recipe 480.

In some embodiments of the invention, not all of the steps of the method of FIG. 8 need be performed. In one embodiment, steps 510 and 520 need only be performed resulting in a computer-independent implementation of the rule described in step 500. In another embodiment of the invention, one or more rules expressed using computer-independent program instructions are processed using by way of steps 510, 520, and 530 thus resulting in a determination that certain portions of the variable data are intended for placement within the copy hole at a greater frequency that other portions of the variable data.

Any of the above-identified methods can be stored on one or more computer-usable medium having computer-readable program instructions embodied in the medium for processing rules in a variable data print campaign. One such method directs the computer system to receive, from a print campaign manager using the computer, rules that specify the variable data to be printed within a copy hole of the print articles of the variable data print campaign, as described in step 500. The method further includes processing a first style sheet and the plurality of rules, the processing resulting in a second style sheet, wherein the first and second style sheets are expressed using computer-independent program instructions, as described in step 510.

While the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

APPENDIX A
Additional exemplary rule descriptions including
the description of rule 150 of FIG. 2.

```
<?xml version=“1.0” encoding=“UTF-8”?>
<?xml-stylesheet type=“text/xsl” href=“C:\CVS\rainier\design\
VDcreate.xsl”?>
<jobDefinition xmlns:xsi=“http://www.w3.org/2000/10/
XMLSchema-instance”
xsi:noNamespaceSchemaLocation=“C:\CVS\rainier\design\
jobDefinition.xsd”>
  <name/>
  <field>
    <fieldName>PHOTO_1</fieldName>
    <friendlyName/>
    <selector>
      <rule>
        <result>
          <text content=“coffee.pdf”/>
        </result>
        <op concat=“and” optype=“greater_than_or_equal”>
          <column>LastDonation</column>
          <constant>200</constant>
        </op>
      </rule>
      <rule>
        <result>
          <text content=“book.pdf”/>
        </result>
        <op concat=“and” optype=“greater_than_or_equal”>
          <column>LastDonation</column>
          <constant>100</constant>
        </op>
      </rule>
      <default>
        <text content=“cd.pdf”/>
      </default>
    </selector>
  </field>
  <field>
    <fieldName>PHOTO_2</fieldName>
    <friendlyName/>
    <selector>
      <default>
        <column>FamilySize</column>
        <text content=“.tif”/>
      </default>
    </selector>
  </field>
  <field>
    <fieldName>FRONT_MESSAGE_1</fieldName>
    <friendlyName/>
    <selector>
      <default>
        <text content=“You've been a donor &#xA; for”/>
        <column>YearsDonated</column>
        <text content=“ years, so why &#xA; stop now?”/>
      </default>
    </selector>
  </field>
  <field>
    <fieldName>FRONT_MESSAGE_2</fieldName>
    <friendlyName/>
    <selector>
      <default>
        <text content=“Your last Donation of &#xA;”/>
        <column>LastDonation</column>
        <text content=“ dollars entitles &#xA; you to this great gift!”/>
      </default>
    </selector>
  </field>
  <field>
    <fieldName>NAME_FIELD</fieldName>
    <friendlyName/>
    <selector>
      <default>
        <column>FirstName</column>
        <text content=“ ”/>
        <column>LastName</column>
      </default>
    </selector>
  </field>
  <field>
    <fieldName>ADDRESS_FIELD</fieldName>
    <friendlyName/>
    <selector>
      <default>
        <column>Address</column>
      </default>
    </selector>
  </field>
  <field>
    <fieldName>CITY_FIELD</fieldName>
    <friendlyName/>
    <selector>
      <default>
        <column>City</column>
        <text content=“, ”/>
        <column>State</column>
        <text content=“ ”/>
        <column>Zip</column>
      </default>
    </selector>
  </field>
  <docTemplate/>
</jobDefinition>
```

APPENDIX B
Complete Listing of variable data style sheet 210 (of FIG. 2).

```
<?xml version=“1.0” encoding=“UTF-8”?>
<!-- The following uses a namespace alias to create an output xsl document out: => xsl: in the
output-->
<xsl:stylesheet version=“1.0” xmlns:xsl=“http://www.w3.org/1999/XSL/Transform”
xmlns:out=“output.xsl”>
<xsl:output indent=“yes”/>
<xsl:namespace-alias stylesheet-prefix=“out” result-prefix=“xsl”/>
<xsl:template name=“result”>
  <xsl:for-each select=“./*”>
    <xsl:choose>
      <xsl:when test=“name()=‘text’”>
        <out:text xml:space=“preserve”><xsl:value-of select=“@content”/></out:text>
      </xsl:when>
      <xsl:otherwise>
        <xsl:element name=“out:value-of”>
          <xsl:attribute name=“select”><xsl:value-of select=“.”/></xsl:attribute>
        </xsl:element>
      </xsl:otherwise>
    </xsl:choose>
  </xsl:for-each>
</xsl:template>
<xsl:template name=“optest”>
  <xsl:value-of select=“op/column”></xsl:value-of>
  <xsl:choose>
    <xsl:when test=“op/@optype=‘equal_to’”><xsl:text>=</xsl:text></xsl:when>
    <xsl:when test=“op/@optype=‘not_equal_to’”><xsl:text>!=</xsl:text></xsl:when>
    <xsl:when test=“op/@optype=‘less_than’”><xsl:text>&amp;lt;</xsl:text></xsl:when>
    <xsl:when test=“op/@optype=‘greater_than’”><xsl:text>&amp;gt;</xsl:text></xsl:when>
    <xsl:when test=“op/@optype=‘less_than_or_equal’”><xsl:text>&amp;lt;=</xsl:text></xsl:when>
    <xsl:when
test=“op/@optype=‘greater_than_or_equal’”><xsl:text>&amp;gt;=</xsl:text></xsl:when>
  </xsl:choose>
  <xsl:text>'</xsl:text>
  <xsl:value-of select=“op/constant”></xsl:value-of>
  <xsl:text>'</xsl:text>
</xsl:template>
<xsl:template name=“VDcreate” match=“/jobDefinition”>
  <out:stylesheet version=“1.0”>
    <out:output indent=“yes”/>
    <out:template match=“/Import”>
      <results>
        <out:for-each select=“/Import/Row”>
          <result>
            <xsl:for-each select=“/jobDefinition/field”>
              <xsl:element name=“{fieldName}”>
                <xsl:for-each select=“selector”>
                  <out:choose>
                    <xsl:for-each select=“rule”>
                      <xsl:element name=“out:when”>
                        <xsl:attribute name=“test”><xsl:call-template
name=“optest”/></xsl:attribute>
                        <xsl:for-each select=“result”>
                          <xsl:call-template name=“result”/>
                        </xsl:for-each>
                      </xsl:element>
                    </xsl:for-each>
                    <xsl:element name=“out:otherwise”>
                      <xsl:for-each select=“default”>
                        <xsl:call-template name=“result”/>
                      </xsl:for-each>
                    </xsl:element>
                  </out:choose>
                </xsl:for-each>
              </xsl:element>
            </xsl:for-each>
          </result>
        </out:for-each>
      </results>
    </out:template>
  </out:stylesheet>
</xsl:template>
                            </xsl:stylesheet>
```

APPENDIX C
Complete listing of exemplary List Processor XSL style
sheet (230) of FIGS. 3 and 4.

```
<?xml version=“1.0” encoding=“UTF-8”?>
<out:stylesheet xmlns:out=“http://www.w3.org/1999/XSL/
Transform” version=“1.0”>
  <out:output indent=“yes”/>
  <out:template match=“/Import”>
    <results>
      <out:for-each select=“/Import/Row”>
        <result>
          <PHOTO_1>
            <out:choose>
              <out:when test=“LastDonation&gt;=‘200’”>
                <out:text xml:space=“preserve”>coffee.pdf</out:text>
              </out:when>
              <out:when test=“LastDonation&gt;=‘100’”>
                <out:text xml:space=“preserve”>book.pdf</out:text>
              </out:when>
              <out:otherwise>
                <out:text xml:space=“preserve”>cd.pdf</out:text>
              </out:otherwise>
            </out:choose>
          </PHOTO_1>
          <PHOTO_2>
            <out:choose>
              <out:otherwise>
                <out:value-of select=“FamilySize”/>
                <out:text xml:space=“preserve>.tif</out:text>
              </out:otherwise>
            </out:choose>
          </PHOTO_2>
          <FRONT_MESSAGE_1>
            <out:choose>
              <out:otherwise>
                <out:text xml:space=“preserve”>You've been a donor
for </out:text>
                <out:value-of select=“YearsDonated”/>
                <out:text xml:space=“preserve”> years, so why
stop now?</out:text>
              </out:otherwise>
            </out:choose>
          </FRONT_MESSAGE_1>
          <FRONT_MESSAGE_2>
            <out:choose>
              <out:otherwise>
                <out:text xml:space=“preserve”>Your last Donation of
</out:text>
                <out:value-of select=“LastDonation”/>
                <out:text xml:space=“preserve”> dollars entitles
you to this great gift!</out:text>
              </out:otherwise>
            </out:choose>
          </FRONT_MESSAGE_2>
          <NAME_FIELD>
            <out:choose>
              <out:otherwise>
                <out:value-of select=“FirstName”/>
                <out:text xml:space=“preserve”> </out:text>
                <out:value-of select=“LastName”/>
              </out:otherwise>
            </out:choose>
          </NAME_FIELD>
          <ADDRESS_FIELD>
            <out:choose>
              <out:otherwise>
                <out:value-of select=“Address”/>
              </out:otherwise>
            </out:choose>
          </ADDRESS_FIELD>
          <CITY_FIELD>
            <out:choose>
              <out:otherwise>
                <out:value-of select=“City”/>
                <out:text xml:space=“preserve”>, </out:text>
                <out:value-of select=“State”/>
                <out:text xml:space=“preserve”> </out:text>
                <out:value-of select=“Zip”/>
              </out:otherwise>
            </out:choose>
          <CITY_FIELD>
        </result>
      </out:for-each>
    </results>
  </out:template>
</out:stylesheet>
```

What is claimed is:

1. A method for processing a rule using computer-independent program instructions, comprising:
describing a rule that determines variable data to be printed on a print article in a variable data print campaign; and
processing a first style sheet and the rule resulting in a second style sheet, the first and second style sheets being expressed in computer-independent program instructions.

2. The method of claim 1, additionally comprising processing the second style sheet and a record resulting in one of text and an asset filename for a copy hole on the print article.

3. The method of claim 2, additionally comprising:
specifying a template that describes the copy hole for the print article; and
processing the template and a third style sheet that results in a format for the variable data used in the print campaign, the third style sheet being expressed in computer-independent program instructions.

4. The method of claim 3, additionally comprising processing the format for the variable data for use in the variable data print campaign and the one of the text and the asset filename for the copy hole resulting in a list of commands that control the operation of a printing device that prints the print article.

5. The method of claim 1, wherein the rule is specified using a structured data text format.

6. The method of claim 5, wherein the structured data text format is an extensible markup language.

7. A method for processing a plurality of rules using computer-independent program instructions, comprising:
processing a first style sheet and the plurality of rules resulting in a second style sheet, the first and second style sheets including computer-independent program instructions;
processing the second style sheet and a plurality of records resulting in variable data being intended for placement within a copy hole on each of the plurality of print articles; and
analyzing the variable data intended for placement in the copy hole to determine that certain portions of the variable data are intended for placement within the copy hole at a greater frequency that other portions of the variable data.

8. The method of claim 7, wherein the plurality of rules are specified using a structured data text format.

9. The method of claim 8, wherein the structured data text format is an extensible markup language.

10. The method of claim 7, wherein the plurality of records includes contact information for recipients of the plurality of print articles.

11. The method of claim 7, wherein the computer-independent program instructions are written in an extensible style language.

12. The method of claim 7, wherein the variable data includes at least one of text and a filename of a photographic asset.

13. A computer-usable medium having computer-readable program instructions embodied in the medium for processing rules in a variable data print campaign, the computer-usable medium including a method that comprises:
receiving, from a print campaign manager using the computer, a plurality of rules that specify variable data to be printed within a copy hole of a plurality of print articles of the variable data print campaign; and
processing a first style sheet and the plurality of rules, the processing resulting in a second style sheet, the first and second style sheets each including computer-independent program instructions.

14. The computer-usable medium of claim 13, in which the computer-usable medium includes a method that additionally comprises the step of processing the second style sheet and a plurality of records resulting in one of text and an asset filename for at least one copy hole on the plurality of print articles.

15. The computer-usable medium of claim 14, wherein the plurality of records includes contact information for recipients of the plurality of print articles.

16. The computer-usable medium of claim 14, in which the computer-usable medium includes a method that additionally comprises the steps of:
specifying a template that describes the at least one copy hole for the plurality of print articles; and
processing the template and a third style sheet that results in a format for the variable data used in the variable data print campaign, the third style sheet including computer-independent program instructions.

17. The computer-usable medium of claim 16, in which the computer-usable medium includes a method that additionally comprises the step of processing the format for the variable data used in the print campaign and the one of the text and the asset filename for the copy hole resulting in a list of commands that controls the operation of a printing device that prints the plurality of print articles.

18. The computer-usable medium of claim 13, wherein the rule is specified using a structured data text format.

19. The computer-usable medium of claim 18, wherein the structured data text format is an extensible markup language.

20. A computer for processing a print campaign rule using computer-independent program instructions, comprising:
a memory that includes a first style sheet and a rule that governs a print campaign, the memory also including a processor that is a software framework for processing the first style sheet and the rule, the first style sheet and the rule including computer-independent program instructions; wherein
the processor is loaded into a central processing unit, and wherein the central processing unit acts on the first style sheet and the rule resulting in an output style sheet that includes computer-independent program instructions.

21. The computer of claim 20, wherein the rule is expressed using a structured data text format.

22. The computer of claim 21, wherein the structured data text format is an extensible markup language.

23. The computer of claim 20, wherein the computer-independent program instructions are written in extensible style language.
